(19) United States
(12) Patent Application Publication
(10) Pub. No.: US 2024/0231341 A1
(43) Pub. Date: Jul. 11, 2024

(54) DEVICE AND METHOD FOR DETERMINING A PROBABLE NUMBER OF REMOVAL ATTEMPTS FOR SUCCESSFUL AUTOMATED REMOVAL OF A COMPONENT CUT OUT OF A METAL SHEET FROM THE METAL SHEET

(71) Applicant: TRUMPF Werkzeugmaschinen SE + Co. KG, Ditzingen (DE)

(72) Inventors: Jonathan EBERLE, Filderstadt (DE); Antje RELITZ, Berlin (DE); Jens OTTNAD, Karlsruhe (DE)

(21) Appl. No.: 18/611,752

(22) Filed: Mar. 21, 2024

Related U.S. Application Data
(63) Continuation of application No. PCT/EP2022/074902, filed on Sep. 7, 2022.

(30) Foreign Application Priority Data
Sep. 23, 2021 (DE) 10 2021 124 706.3

(51) Int. Cl. G05B 19/418; G05B 19/406

(52) U.S. Cl. CPC G05B 19/41865; G05B 19/406

(57) ABSTRACT

A method for determining a probable number of removal attempts for successful automated removal of a component cut out of a metal sheet from the metal sheet is provided. The component is to be removed from the metal sheet by an automated removal tool. Multiple removal attempts are possible during the automated removal of the component. The method includes reading in a shape of the component, reading in a parameter of the automated removal tool, and determining the probable number of removal attempts based on the shape of the component and the parameter of the automated removal tool.

### CROSS REFERENCE TO RELATED APPLICATIONS

This application is a continuation of International Application No. PCT/EP2022/074902 (WO 2023/046484 A1), filed on Sep. 7, 2022, and claims benefit to German Patent Application No. DE 10 2021 124 706.3, filed on Sep. 23, 2021. The aforementioned applications are hereby incorporated by reference herein.

### FIELD

Embodiments of the present invention relate to a method for determining a probable number of removal attempts for successful automated removal of a component cut out of a metal sheet from the metal sheet.

Embodiments of the present invention further relate to a device for carrying out a method according to embodiments of the invention.

### BACKGROUND

DE102018215738A1 discloses a method for removing workpiece parts from a residual workpiece with a plurality of removal attempts.

DE102018208126A1 discloses a method for generating a removal prediction.

### SUMMARY

Embodiments of the present invention provide a method for determining a probable number of removal attempts for successful automated removal of a component cut out of a metal sheet from the metal sheet. The component is to be removed from the metal sheet by an automated removal tool. Multiple removal attempts are possible during the automated removal of the component. The method includes reading in a shape of the component, reading in a parameter of the automated removal tool, and determining the probable number of removal attempts based on the shape of the component and the parameter of the automated removal tool.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a flow chart of a method according to embodiments of the invention; and

FIG. 2 shows a schematic illustration of a machine for laser cutting with a removal tool according to some embodiments.

### DETAILED DESCRIPTION

Embodiments of the invention provide a method by means of which the removal process can be predicted better. With better prediction of the removal process, the production process of which the removal process is part can be controlled better.

According to some embodiments, a method for determining a probable number of removal attempts for successful automated removal of a component cut out of a metal sheet from the metal sheet, wherein the component is to be removed from the metal sheet by an automated removal tool, wherein multiple removal attempts are possible during the automated removal of the component, the method comprising the steps of:
a. reading in a shape of the component,
b. reading in a parameter of the automated removal tool,
c. determining the probable number of removal attempts based on the shape of the component and the parameter of the automated removal tool.

The shape of the component can come from design data for the cutting process of the component, for example. Such design data can come from a CAD program, for example. The design data are typically available in what is known as a Manufacturing Execution System (MES) and can be read out from the MES. Alternatively, the data can be determined from a camera recording of the cut metal sheet by image processing.

The removal tool can comprise a multiplicity of push-out elements and counter-holding elements, for example. The parameter of the removal tool can be the type of removal tool, the number and/or arrangement of push-out elements, the number and/or arrangement of counter-holding elements, the push-out speed, the push-out acceleration, a value for wear or the presence of a hold-down device, for example. The method can be improved by the simultaneous use of a plurality of parameters.

The probable number of removal attempts is preferably determined from empirical values for components of the same or similar shape and removal tools with the same or a similar parameter.

Preferably, a plurality of possible numbers of removal attempts with associated probability values is determined in the determination. By determining a plurality of possible numbers of removal attempts with associated probability values, it is possible to assess the reliability of determination. If there are only a few possible numbers with high probability values, the reliability of determination is high. If there are many possible numbers of removal attempts with similar probability values, the reliability of determination is low.

Preferably, a probability of failure of automated removal is determined in the determination of the probable number of removal attempts. Failure of automated removal can be assumed, for example, if a predetermined maximum number of removal attempts is exceeded.

Preferably, a time for successful automated removal is determined from the probable number of removal attempts. By determining the probable time for automated removal of a component, the probable duration for sorting out the metal sheet and/or the working time of the automated removal tool can be determined. Production planning and/or work planning can thereby be significantly improved.

Preferably, the probable number of removal attempts is determined for a multiplicity of components. As a particular preference, a removal sequence for the multiplicity of components is determined based on the probable number of repeated attempts.

Preferably, components with a low probable number of repeated attempts are sequenced ahead of components with a high probable number of repeated attempts in the removal sequence. The risk of failure of automatic removal typically rises with the probable number of repeated attempts. By means of the proposed removal sequence, the components with a low probability of failure are sorted out first.

The component is preferably to be cut from a metal sheet by a production machine, wherein at least one parameter of the production machine is read in, and the parameter of the production machine is taken into account in determining the probable number of removal attempts. The production parameter is a type of material, a material thickness, a type of production machine, a cutting parameter or a value for wear. A cutting parameter is, for example, a cutting width, a feed rate, a tip type of a laser cutting head or a distance between the tip of a laser cutting head and the metal sheet. Production parameters are critical determinants of the probable number of removal attempts. By taking into account one or more production parameters, it is possible to improve the determination of the probable number of removal attempts.

When the production machine is to be used in different production shifts, wherein different response times of a machine operator of the production machine are known for different production shifts, components with a high probable number of removal attempts are planned for a production shift in which the response time of a machine operator is short. By means of such planning of the components for production shifts, the production flow and thus also production planning can be improved since a short response time of a machine operator is ensured in the case of components with a high probable number of removal attempts and thus a high probability of failure of automatic removal.

An artificial intelligence system, in particular a trained neural network, is preferably used to determine the probable number of removal attempts. An artificial intelligence system can learn to determine the probable number of removal attempts on the basis of previous removal attempts. Moreover, an artificial intelligence system can be trained further with each component removed. It is thereby possible to improve the determination of the probable number of removal attempts.

Embodiments of the invention also provide a computer program product for carrying out a method according to embodiments of the invention by means of a computer.

Embodiments of the invention also provide a device having a computing unit and a memory, wherein a computer program with instructions for carrying out a method according to embodiments of the invention is stored in the memory, wherein the computing unit is provided and configured for carrying out the method.

The following description of preferred embodiments serves to explain the invention in greater detail in association with the drawings.

Elements that are the same or have equivalent functions are denoted by the same reference signs in all the exemplary embodiments.

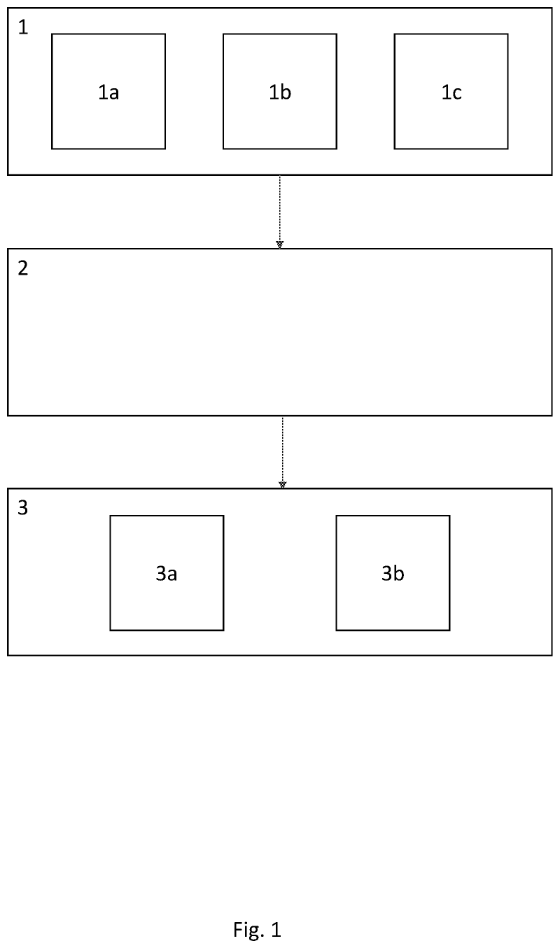

FIG. 1 shows an illustrative flow chart of a method according to embodiments of the invention. In a first step 1, the required data are read in. In this case, the first step 1 is divided into reading in the shape of the component 1a and reading in one or more parameters of the removal tool 1b. Here, the data for the two partial steps can be read out from one or more memories. The parameter of the removal tool can also be a fixed predetermined parameter if the method is to be carried out for only a predetermined removal tool. In addition, a production parameter is read in 1c in this example. Here, a type of material, in this case stainless steel, a material thickness, in this case 1 mm, and a cutting width, in this case 1 mm, are read in as production parameters. The production parameters are preferably read in together with the shape of the component.

In a second step 2, the probable number of removal attempts required is determined. In this example, this is accomplished by an artificial intelligence system. In this example, the artificial intelligence system is designed as a neural network. The neural network was trained for different components by means of a multiplicity of removal attempts. The artificial intelligence system can be trained for specific removal tools and/or production machines. In this case, the parameters for the removal tool and/or production machine are inherent in the artificial intelligence system.

The first two steps are carried out for a multiplicity of components. Production parameters which are valid for a plurality of components are preferably read in only once.

For example, the type of material and material thickness for a metal sheet from which a plurality of components is cut may be identical for all the components, and the shape and cutting width for the components may differ.

In a third step 3, the result of the determination of the probable number of removal attempts required is used for production planning. In this example, the result is used in a first variant 3a to determine a removal sequence for the multiplicity of components. In this case, components with a low probable number of repeated attempts are sequenced before components with a high probable number of repeated attempts since the risk of failure of automatic removal increases with the probable number of repeated attempts. Accordingly, the components with a low probability of failure are sorted out first. As a result, there is less interruption in automatic sorting at the start of sorting. In a second variant 3b, the result is used for planning production shifts. It is advantageous here if different response times of a machine operator of the production machine are known for different production shifts. Components with a high probable number of removal attempts are then planned for a production shift in which the response time of a machine operator is short. As a result, interruptions in the sorting process caused by failed removal attempts are kept short.

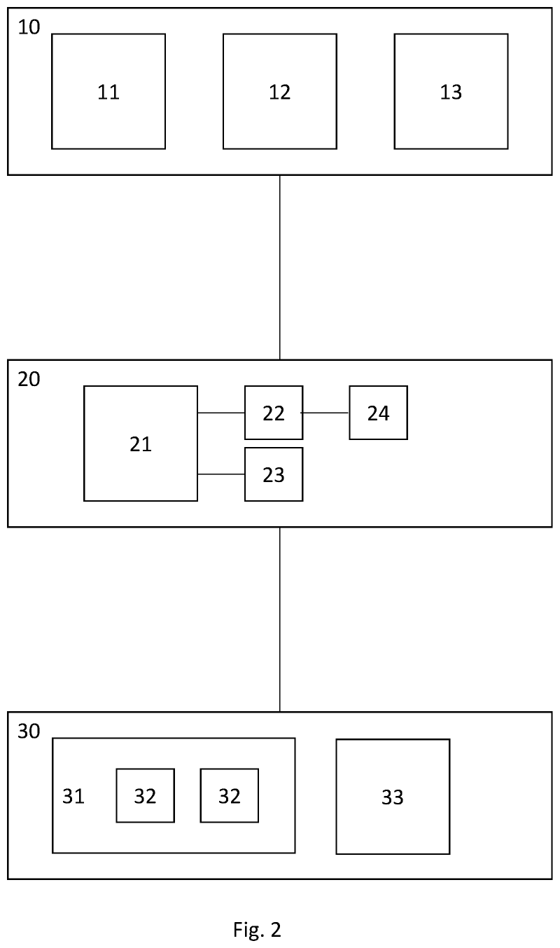

FIG. 2 shows an illustrative structure of a device for carrying out a method according to embodiments of the invention. A memory 10 contains data on the shape 11 of the component, parameters 12 of the removal tool and production parameters 13. A computing unit 20 loads the data 11, 12, 13 from the memory 10. From the shape 11 of the component, the parameter 12 of the removal tool and the production parameter 13, the computing unit 20 determines the probable number of removal attempts 22. For this purpose, the computing unit uses an artificial intelligence system 21. In this example, the artificial intelligence system is in the form of a trained neural network. The neural network was trained for a multiplicity of components of different shapes by means of a multiplicity of removal attempts. The artificial intelligence system determines a plurality of possible numbers of removal attempts with associated probability values. In addition, the artificial intelligence system determines a probability 23 for the failure of automated removal. From the probable number of removal attempts 22, the computing unit 20 determines a probable time 24 for successful automated removal.

From the memory 10, the computing unit 20 reads information on a number of production shifts, in particular on response times of a machine operator in the production shifts. Together with the probable number of removal attempts 22 and the probability 23 of failure of automated removal, the computing unit 20 plans for the components in the production shifts. In this case, components with a high probable number of removal attempts 22 are then planned for a production shift in which the response time of a machine operator is short.

Based on the probable number of removal attempts 22 and the probability 23 of failure of automated removal, the computing unit 20 plans a sorting sequence for the components cut from a metal sheet. In this case, components with a low probable number of removal attempts 22 are sequenced before components with a high probable number of removal attempts 22.

In this example, the computing unit 20 is part of a Manufacturing Equipment System (MES) 25. The MES 25 controls a production machine 30. The production machine 30 comprises a removal tool 33.

A production machine 30 cuts the components 32 out of a metal sheet 31. The components 32 are then removed in an automated manner from the metal sheet 31 by means of a removal tool 33. An illustrative production machine 30 with a removal tool 33 is known from DE102018215738A1. The disclosure of DE102018215738A1 is herewith fully incorporated. The number of removal attempts which is required for automated removal is stored and used together with the shape of the component and the production parameters to improve the artificial intelligence system.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1a Reading in a shape of the component
1b Reading in a parameter of the automated removal tool
1c Reading in a production parameter
2 Determining the probable number of removal attempts
3a Determining the removal sequence
3b Planning a production shift
10 Memory
11 Shape of the component
12 Parameter of the removal tool
13 Production parameter
20 Computing unit
21 Artificial intelligence system
22 Number of removal attempts
23 Probability of failure
24 Time for removal
25 MES
30 Production machine
31 Metal sheet
32 Component
33 Removal tool

1. A method for determining a probable number of removal attempts for successful automated removal of a component cut out of a metal sheet from the metal sheet,
wherein the component is to be removed from the metal sheet by an automated removal tool,
wherein multiple removal attempts are possible during the automated removal of the component,
the method comprising:
reading in a shape of the component,
reading in a parameter of the automated removal tool, and
determining the probable number of removal attempts based on the shape of the component and the parameter of the automated removal tool.

2. The method as claimed in claim 1, wherein the determination of the probable number of removal attempts comprises determining a plurality of possible numbers of removal attempts and associated probability values.

3. The method as claimed in claim 1, wherein the determination of the probable number of removal attempts comprises determining a probability of failure of automated removal.

4. The method as claimed in claim 1, further comprising determining a time for successful automated removal from the probable number of removal attempts.

5. The method as claimed in claim 1, wherein the probable number of removal attempts is determined for each of a multiplicity of components.

6. The method as claimed in claim 5, further comprising determining a removal sequence for the multiplicity of components based on the probable number of removal attempts.

7. The method as claimed in claim 6, wherein components with a low probable number of removal attempts are sequenced ahead of components with a high probable number of removal attempts in the removal sequence.

8. The method as claimed in claim 1, wherein the component is to be cut from a metal sheet by a production machine,
the method further comprising read in at least one production parameter, wherein the determination of the probable number of removal attempts takes into account the production parameter.

9. The method as claimed in claim 8, wherein the production parameter is a type of material, a material thickness, a type of production machine, a cutting parameter, or a value for wear.

10. The method as claimed in claim 6, wherein the production machine is to be used in different production shifts,
wherein different response times of a machine operator of the production machine are known for different production shifts, and
components with a higher probable number of removal attempts are planned for a production shift in which the response time of the machine operator is shorter.

11. The method as claimed in claim 1, wherein an artificial intelligence system comprising a trained neural network is used to determine the probable number of removal attempts.

12. A non-transitory computer-readable medium having program steps stored thereon, the program steps, when executed by a computer processor, causing performance of a method as claimed in claim 1.

13. A device comprising a computing unit and a memory,
wherein a computer program with instructions for carrying out a method as claimed in claim 1 is stored in the memory,
wherein the computing unit is configured for carrying out the method.
